(19) United States
(12) Patent Application Publication
(10) Pub. No.: US 2026/0241289 A1
(43) Pub. Date: Aug. 20, 2026

(54) GENERATING AI-PERSONALIZED TRAILER FOR A VIDEO GAME

(71) Applicant: SONY INTERACTIVE ENTERTAINMENT INC., Tokyo (JP)

(72) Inventors: Bethany Tinklenberg, San Mateo, CA (US); Crystal Fiel, Foster City, CA (US); Elizabeth Ruth Juenger, San Francisco, CA (US); Adrian Harris, San Mateo, CA (US); Tatianna Forget, San Mateo, CA (US)

(21) Appl. No.: 19/058,649

(22) Filed: Feb. 20, 2025

(51) Int. Cl. A63F 13/60; A63F 13/79

(52) U.S. Cl. CPC A63F 13/60; A63F 13/79

(57) ABSTRACT

Techniques include determining an interest of a user based at least in part on video game console data associated with an account of the user. Techniques further include determining, based at least in part on the interest of the user, a set of content sections from video content of a video game. Techniques further include generating a trailer for the video game based at least in part on the set of content sections. Techniques further include causing a presentation of the trailer on a user device associated with the account.

### BACKGROUND

A video game console is a device with a processor, a memory, and other components configured for video game content. Video game content can include a trailer about an upcoming or available video game. This video game content can be received from a server and presented, by an application of the video game console, on a display.

### BRIEF DESCRIPTION OF THE DRAWINGS

Features, embodiments, and advantages of the present disclosure are better understood when the following Detailed Description is read with reference to the accompanying drawings.

FIG. 1 illustrates an example of using a trailer generation system, according to certain embodiments of the present disclosure.

FIG. 2 illustrates an example of a trailer generation system, according to certain embodiments of the present disclosure.

FIG. 3 illustrates an example of a trailer generation system, according to certain embodiments of the present disclosure.

FIG. 4 illustrates an example of a system for training a machine learning model, according to certain embodiments of the present disclosure.

FIG. 5 illustrates an example of a process for using a trailer generation system, according to certain embodiments of the present disclosure.

FIG. 6 illustrates an example of a hardware system suitable for implementing a computer system, according to certain embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described herein can enable trailers to be generated based on interests of a user. Trailers can include a video file, audio file, and/or image file that is/are used to present content on a user interface of a device (e.g., a game console). Trailers may be presented using an application (e.g., a video player) that runs on the device. Trailers can showcase key scenes, characters, gameplay, and/or plot elements without revealing too much, sparking curiosity and emotional connection. Trailers customized to users can more effectively spark curiosity and emotional connection with a video game.

Additionally, automated generation of trailers results in significant efficiency gains, saving time and resources that would otherwise be spent manually creating trailers for each video game, or worse, for each user (previously not practically possible). Further, many existing trailers do not include variants and therefore, the trailers may not be easily presented as a different length (e.g., 30 second trailer, one minute trailer, etc.), to comply with different constraints set by a system, constraints set by a user configuration, and/or interests of a user. Furthermore, since many existing trailers do not include variants, they therefore may not showcase features of a video game that correspond to interests determined from game console data.

When trailer variants do not exist, variant trailers cannot be presented. When variant trailers do not exist, presentation of trailers based on attributes associated with an account (e.g., gender, age, interests, etc.) cannot be performed. Automated generation of trailers can resolve the above described issues, among others. For example, by automating generation of trailers, many trailers and/or variant trailers (e.g., customized trailers based on determined interest(s)) can be generated using fewer resources and time compared to traditional techniques.

Further, automated generation of trailers can ensure consistency and/or adherence to trailer constraints (e.g., based on branding guidelines, display constraints, national laws, customs, and/or norms, etc.), which may result in a cohesive look and/or feel across trailers. Customized trailers can also enhance accessibility by including visual cues or text overlays that provide additional context about the content represented by the trailer, making it easier for a wider audience, including those with disabilities (e.g., visual disabilities, hearing disabilities, etc.), to understand the content.

Trailers can be custom generated for a specific video game based on the interests of a user. As a result, techniques enable complex pattern recognition to take place and cause video game trailers to be generated on a per user account basis based on the recognized patterns. The customized generation of video game trailers can enable content to be served more efficiently to users. For example, in certain embodiments, instead of a video game developer developing a video game trailer they hope resonates with users, techniques described herein can generate video games trailers that are more likely to resonate with users and can do so on a per user basis. Accordingly, video game developers may not need to use computing resources to generate trailers that may not be of interest to users that watch the trailers.

The interests of a user can be determined using game console data. The game console data may be received from a game console associated with a user account of the user, applications executing on the game console and associated with the user account (e.g., video game applications, news applications, music applications, social media applications, etc.), and/or applications executing remotely from the game console and associated with the user account (e.g., video game applications, news applications, etc.). The game console data may be associated with a user account used with a game console. The game console data may include explicit and/or implicit indications of interests associated with the user account. For example, an explicit indication of an interest may include an answer to a question where user input was received indicating that a user of the user account likes adventure games, like realistic looking games, like sandbox games, likes co-op games, likes player versus player games, etc. An implicit indication may be an interest indication determined from an analysis of game console data that does not explicitly indicate the interest. For example, game console data representing that the user account owns a lot of sandbox games can implicitly indicate that the user likes sandbox games. As another example, game console data representing that the user account has recently played 30 hours of a single sports game may indicate that a user has an interest in sports games (e.g., possibly even if the user account also owns a lot of sandbox games but has not recently played them).

The game console data can be input to an interest determination system (e.g., including a machine learning model) that is configured to determine one or more interests associated with a user account based on game console data associated with the user account. The machine learning model may determine the interests of the user based on patterns recognized from training of the machine learning model. The training data may be based on game console data of a set of users and corresponding interests. The interests may be determined based on features (e.g., indicating whether a video game is a sandbox game, a simulation game, a building game, a coop game, etc.) of video games in a game library associated with the set of users.

After one or more interests associated with a user account are determined, techniques may further enable a set of content (e.g., pictures, video, and/or audio, etc.) to be selected based on the interests and the video game the trailer is to be generated for. The content may be from a general set of content compiled from one or more sources (e.g., video game developers, retailers, marketing, players, and/or streams, etc.). The content may include gameplay, cutscenes, content authored for use in a trailer, etc. The content may be selected based on constraints. The constraints may be set by the trailer generation system, another system, or a user. For example, a user account the trailer will be associated with may have set up constraints that indicate they want trailers that are, at most, 60 seconds long. The constraints may be set by a system such that a generated trailer includes at least authored content and up to 30 seconds of other content that is most relevant based on the determined interests.

All of the selected content or portions of the selected content may be combined and included in the trailer along with transitions, a specific presentation order, overlays, etc. The combined content may be associated with a user account so that it can be presented to a user of the user account. For example, a generated trailer may be pushed to the user in a notification for a video game they might find appealing. In an example, the generated trailer is pulled by a game console of the user after the user navigates to a page of a virtual store associated with the video game the trailer was generated for.

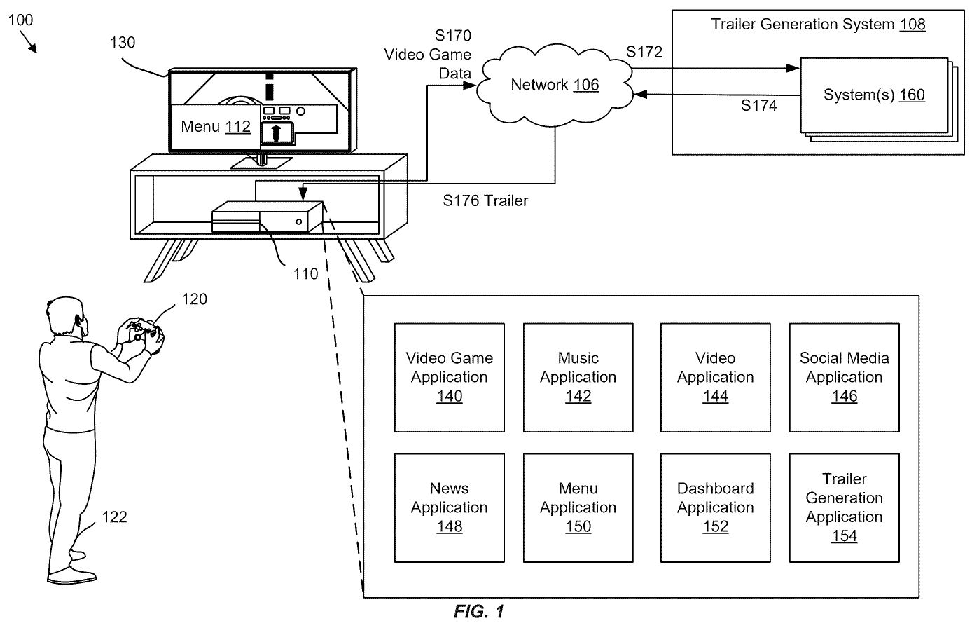

FIG. 1 illustrates an example of using a trailer generation system 108, according to certain embodiments of the present disclosure. The trailer generation system 108 may be used as part of a computer system 100. As illustrated, the computer system can include a video game console 110, a video game controller 120, a display 130, a network 106, and/or a trailer generation system 108. The trailer generation system 108 may be included in a backend system, such as a set of cloud servers, that is communicatively coupled with the video game console 110 and/or be included in the video game console 110. The video game console 110 can be communicatively coupled with the video game controller 200 (e.g., over a wireless network) and with the display 130 (e.g., over a communications bus). A user 122 can operate the video game controller 200 to interact with the video game console 110. These interactions may include playing a video game presented on the display 130, interacting with a menu 112 presented on the display 130, and/or interacting with other applications of the video game console 110 (e.g., with media applications to stream media from an online content source or to play a media file from the local storage of the video game console 110).

The video game console 110 includes a processor and a memory (e.g., a non-transitory computer-readable storage medium) storing computer-readable instructions that can be executed by the processor and that, upon execution by the processor, cause the video game console 110 to perform operations related to various applications. In particular, the computer-readable instructions can correspond to program codes for the various applications of the video game console 110 including video game application 140, music application 142, video application 144, social media application 146, and news application 148. A video game application, such as video game application 140, generally represents a computer application executable to present video game content, receive user interaction with the video game content, and accordingly update the video game content. A media application, such as music application 142, video application 144, social media application 146, and news application 148, generally represents a computer application executable to present media content including audio, video, and/or other media types, receive user interaction with the media content, and accordingly update the media content. The media content can be streamed from a remote content source or can be presented from local storage of the video game console 110. Further, other applications can be likewise included in the video game console 110, such as a chat application. The availability of a video game application, media application, and/or other type of computer application to the user 122 via the video game console 110 can depend on a user identifier of the user 122 (e.g., upon a login to the video game console 110, the availability of the computer applications can depend on the user identifier used in the login).

In addition, the video game console 110 includes a menu application 150, a dashboard application 152, and a trailer generation application 154. The menu application 150 can present a home user interface (UI) in a GUI of the display 130. The dashboard application 152 can present an arrangement of interactive UI widgets in a dashboard page on the GUI. The trailer generation application 154 may implement the trailer generation system 108 or portions of the trailer generation system 108. The trailer generation application 154 may present the generated, store, and/or transmit the generated trailer. In certain embodiments, the video game console 110 can include a trailer generation application that performs operations like those describes with respect to the trailer generation system 108.

The video game controller 120 is an example of an input device. The video game controller 200 may allow the user 122 to interact with one or more GUIs presented by the video game console 110 on the display 130. For example, using one or more directional control inputs (e.g., a joystick and/or a directional pad) the user can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands.

Upon an execution of the video game application 140 by the video game console 110, a rendering process of the video game console 110 presents video game content (e.g., illustrated as a car race video game content) on the display 130. In certain embodiments, the video game application 140 may be executed/running on a server (e.g., a cloud gaming system) and rendered by the video game console 110. In certain embodiments, the video game application 140 may be executed/running on a server and rendered by the server before the rendered video game content is transmitted to the video game console 110 for display. Upon user input from the video game controller 200 (e.g., a user push of a particular key or button), the rendering process also presents the menu 112. Additionally, or alternatively, the menu 112 may be presented as an initial landing page in response to a user powering-on the video game console 110 and/or waking the video game console 110 from a suspended state. Depending on the user input, the menu 112 corresponds to the home UI page, a landing page, or the like. The menu 112 can be presented in a layer over the video game content.

Upon the presentation of the menu 112, the user control changes from the video game application 140 to the menu application 150. Upon receiving a user input from the video game controller 200 requesting interactions with the menu 112, an underlying application (e.g., the menu application 150, the dashboard application 152, etc.) supports such interactions by updating the menu 112 and launching any relevant application in the background or foreground. The user 122 can exit the menu 112 or automatically dismiss the menu 112 upon the launching of an application in the background or foreground. Upon exiting the menu 112 or the dismissal based on a background application launch, the user control changes from the underlying application to the video game application 140.

The video game console 110 may generate game console data. The game console data may include data generated by one or more applications running on the video game console 110. For example, the video game application 140 may generate video game application data. The video game application data may include data representing levels completed, achievements unlocked, and missions accomplished, within the video game, time of day when the video game application is used, session duration, and total time spent playing the video game, how often the user 122 plays the video game, choices made during gameplay (e.g., character selection, weapon preferences, or strategies), preferred difficulty level (e.g., easy, medium, hard), location data, game genre, engagement with multiplayer features, chat data, user group data (e.g., who the user 122 plays with), what people have taken screenshots of, an artistic style, and/or a mechanic, etc.

In another example, the news application 148 may generate news data. The news data may include data representing specific articles or topics the user 122 reads (e.g., an article about an upcoming video game or video game feature), how much time the user 122 spends reading a particular article or topic, how often the user opens the app or reads articles, how the user 122 navigates through the app (e.g., scrolling speed, clicks on headlines, links, or ads), keywords or topics the user searches for within the application, content the user chooses to save for later or mark as important, articles or topics the user shares via the social media application 146, use of specific app features, such as notifications, comment sections, or personalization tools, news sources, and/or authors (e.g., a game developer), etc.

In another example, the music application 142 may generate music data. The music data may include data representing frequency of music application usage, time of day when the application is used, and session duration, songs or playlists that are played, skipped, paused, or replayed, songs, albums, artists, or playlists that the user marks as “liked,” “favorited,” or adds to their library, terms or keywords used by the user in the application's search feature, personalized playlists created by the user, which may indicate preferences for specific genres, moods, or themes, songs, playlists, or albums shared with others via the social media application 146, genres the user listens to most often (e.g., rock, jazz, pop, classical), specific artists or albums that are repeatedly played or followed, selection of mood-or activity-based playlists (e.g., “workout,” “relaxation,” “study”), songs or genres associated with specific regions or cultures.

In another example, the video application 144 may generate video data. The video data may include data representing videos (e.g., videos related to certain video games, streams related to certain video games) or shows watched, including completion rates (e.g., fully watched, partially watched, or abandoned), search terms or keywords entered into the video application's search bar, indicating specific interests or queries, actions such as liking, disliking, commenting, sharing, or saving videos to playlists or watchlists, information about when videos are paused, rewound, fast-forwarded, or skipped, time spent watching videos, session lengths, and binge-watching patterns, engagement with suggested videos or curated playlists, types of content frequently viewed (e.g., comedy, drama, sci-fi, documentaries, tutorials), specific creators, influencers, or channels the user 122 follows or frequently watches, interest in specific topics (e.g., cooking, fitness, gaming, technology, travel), languages of the videos watched, reflecting linguistic preferences or fluency, preference for certain formats, such as short-form videos, live streams, or full-length movies, and/or online vs. offline viewing habits, etc.]

In another example, the dashboard application 152 may generate dashboard data. The dashboard data may include data representing application usage patterns, customization choices (e.g., user selected widgets, backgrounds related to a certain video game, layouts, themes, etc.), responses to application notifications, and/or games on a wish list, etc.

In another example, the social media application 146 may generate social media data. The social media data may include data representing posts liked, shared, commented on, saved, or bookmarked, time spent viewing specific posts, videos, or stories (e.g., scrolling past vs. lingering on content), keywords, hashtags, profiles, or topics searched within the social media application 146, frequency, timing, and type of content shared by the user (e.g., text, images, videos, links), views, reactions, and replies, responses to interactive features like polls, quizzes, or surveys within the social media application 146, topics of interests, and/or followed accounts, etc.

Although FIG. 1 illustrates that the different applications are executed on the video game console 110, the embodiments of the present disclosure are not limited as such. Instead, the applications can be executed on the backend system (e.g., the cloud servers) and/or their execution can be distributed between the video game console 110 and the backend system.

The trailer generation system 108 may receive the game console data from the video game console 110, the game console data may be used to generate a trailer (e.g., using a set of one or more systems 160). The trailer may be generated for a video game indicated by the user 122, any of the applications running on the video game console 110, and/or any of the applications running remote to the video game console 110. The generated trailer may be transmitted to the video game console 110 and presented by display 130. The generated trailer may be generated by the trailer generation system 108 based on the console data and the one or more systems 160.

The system(s) 160 may execute code that processes console data (e.g., game data, image data, scene data, audio data, text data, vector data, conditions, etc.). The system(s) 160 may include one or more machine learning models (e.g., machine learning models with frozen parameter weights, a classification model, a diffusion model, a clustering machine learning model, etc.). Systems are referred to and described throughout the description herein. The systems are referred to for the simplicity of explanation. The systems may be implemented using hardware (e.g., a processor, a memory, and/or a graphics card, etc.). The systems may be implemented using a rule based approach (e.g., using a ruleset (e.g., outlining specific conditions and actions to follow)), an algorithm, and/or a trained machine learning model. A system included in the system(s) 160 may include a service and/or hardware local or remote to the other system(s) 160. A rule-based approach may ensure consistent and logical outcomes based on established criteria. A machine learning model can enable the system to adapt and improve its performance over time. Implementing one or more of the system(s) 160 with a machine learning model and/or a rule based approach can enable the system(s) 160 to handle a wide variety of tasks, from dynamic decision-making to structured, rule-driven processes, depending on the requirements of the trailer generation system 108. In certain embodiments, the video game console 110 is implemented by a server.

The trailer may be generated using the game console data, the interests represented by the game console data, and/or a set of content (e.g., picture, video, and/or audio, text, overlays, etc.). The content may include gameplay, cutscenes, content authored for use in a trailer, etc. All of the selected content or portions of the selected content may be combined and included in the trailer along with transitions, a specific presentation order, overlays, etc.

Network 106 may be configured to connect video game console 110 and the trailer generation system 108, as illustrated. The network 106 may be configured to connect any combination of the system components. In certain embodiments, the network 106 is not part of the computer system 100. For example, the trailer generation system 108 may run locally on the video game console 110 and/or one or more of the system(s) 160 may run locally on video game console 110.

Each of the network 106 data connections can be implemented over a public (e.g., the internet) or private network (e.g., an intranet), whereby an access point, a router, and/or another network node can communicatively couple the video game console 110 and the trailer generation system 108. A data connection between the components can be a wired data connection (e.g., a universal serial bus (USB) connector), or a wireless connection (e.g., a radio-frequency-based connection). Data connections may also be made using a mesh network. A data connection may also provide a power connection. A power connection can supply power to the connected component. The data connection can provide for data moving to and from system components. One having ordinary skill in the art would recognize that devices may be communicatively coupled using a network (e.g., a local area network (LAN), wide area network (WAN), etc.). Further devices may be communicatively coupled through a combination of wired and wireless means (e.g., wireless connection to a router that is connected via an ethernet cable to a server).

The computer system 100 may further implement the illustrated steps S170-S176. The illustrated steps may be implemented by executing instructions stored in a memory of the computer system 100, where the execution is performed by processors of the computer system 100.

At step S170, game console data may be transmitted from the video game console 110 to the network 106. The game console data may be generated by an application running on the video game console 110. The game console data may include video game application data, music application data, news application data, etc. The game console data may include data that can be analyzed to determine interests of user 122.

At step S172, the game console data may continue to be transmitted to the trailer generation system 108 from the video game console 110 via the network 106. After the trailer generation system 108 receives the game data, the trailer generation system 108 may use the system(s) 160 to generate the trailer using the game console data and/or vector space embedding of one or more interests generated using the game console data.

In certain embodiments S170 and S172 also include transmitting an indication of a video game to generate the trailer for. The video game the trailer is generated for may be based on information include in the game console data. For example, the game console data may indicate a list of games the user is browsing through, or a list of games the user is about to be shown. The video game the trailer is generated for may be based on a process run by the trailer generation system. For example, the trailer generation system may run a process that causes a trailer for a specific video game (e.g., a video game being promoted to users and/or to users with specific interests) to be generated before the trailer is then transmitted to the video game console 110.

The trailer may be generated using the game console data. The trailer may include one or more content sections that are selected based on the game console data. The content sections may include video content, audio content, image content, text content, and/or another modality of content etc. The content sections may be selected to satisfy certain criteria (e.g., a type of content section, a content section age rating, a content section length, what is shown in the content section, interests of the user 122 determined from the game console data, etc.). The content sections may be ordered based on the type of the content section, interests of the user 122 determined from the game console data, what portion of the game the content section corresponds to, etc. Content sections included in the trailer may each have a length that may or may not be different from lengths of other content section lengths included in the trailer. The trailer may include transitions between content sections.

At step S174, the trailer generation system 108 may transmit the generated trailer (e.g., video file) to the network 106. In certain embodiments, the generated trailer is stored (e.g., by a storage system communicatively coupled with the trailer generation system 108) and can be retrieved by request. The request may indicate a trailer being requested using a video game identifier and an account identifier to indicate that a trailer associated with the account and for the video game is being requested. The trailer may be streamed and/or downloaded to the video game console 110. In certain embodiments, a location identifier (e.g., a Uniform Resource Locator (URL)) is transmitted to the video game console 110 so the video game console can lookup, request, and/or stream the generated trailer after to receiving the URL.

At step S176, the network 106 may transmit the generated trailer to the computing system 104. Upon the video game console 110 receiving the generated trailer, the video game console 110 may present the trailer using a user interface (e.g., display 130). For example, user 122 may be presented with and be able to view the generated trailer. In certain embodiments, upon the video game console 110 receiving the generated trailer, the video game console 110 stores the trailer and associates the trailer with a user account of the user 122.

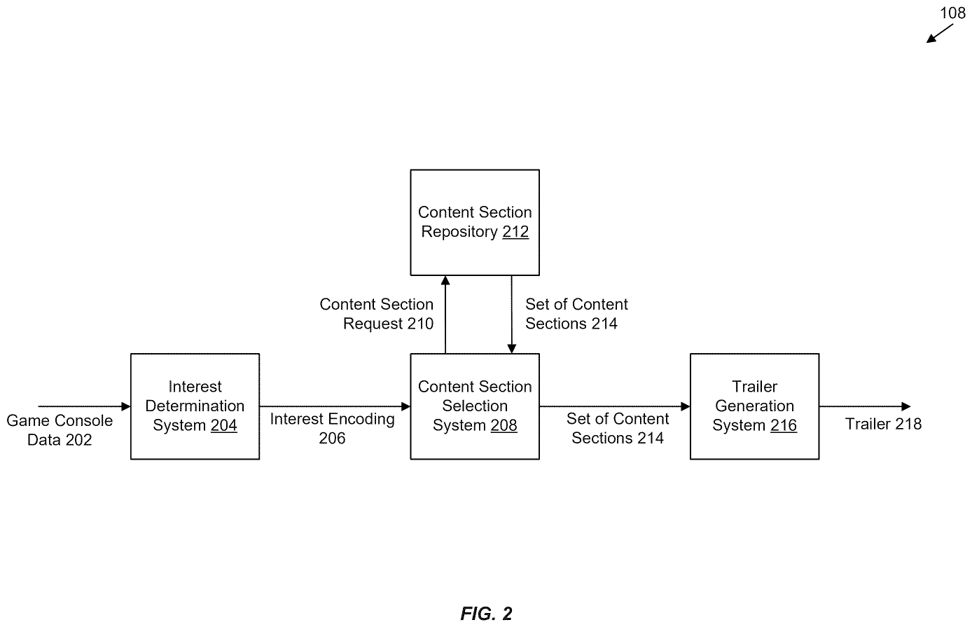

FIG. 2 illustrates an example of a trailer generation system 108 (e.g., trailer generation system 108 described above), according to certain embodiments of the present disclosure. Trailer generation system 108 can include an interest determination system 204, a content section selection system 208, a content section repository 212, and a trailer generation system 216. The trailer generation system 108 can receive game console data 202 from a game console (e.g., video game console 110 associated with the user account, described above) and use the game console data 202 to generate a trailer 218. The trailer generation system 108 can receive game console data 202 from other user devices associated with the user account such as a mobile phone, a tablet, and/or a desktop computer, etc.

The game console data 202 has been described above. The game console data 202 can include patterns that are indicative of interests of users who use the game console. The game console data 202 may be associated with a specific user account, such as a user account signed into the game console while the game console is being used. The game console data may be received, by the interest determination system 204, from the game console, a server, and/or from a system that stores game console data. The game console data 202 may include data collected over a period of time. The game console data 202 may include data associated with a user account and collected from multiple game consoles and/or other user devices.

The interest determination system 204 may determine an interest of a user based at least in part on the game console data 202. Game console data 202 may be associated with a weight. For example, game console data 202 that was received longer ago may be weighted differently than game console data 202 that was more recently received and/or generated. The weighting can enable more recent game console data 202 to have more of an influence on the interest determination. The weighting can enable certain subsets of game console data 202 to have more of an influence on a generated interest encoding 206. For example, the weighting can enable video game application data to be weighted differently than dashboard application data.

The interest determination system 204 may generate the interest encoding 206. The interest encoding 206 may indicate one or more interests of a user. An interest(s) may represent something that the user finds of interest, enjoyable, fun, and/or engaging, etc. Interests may change over time. Something may be of interest to a user because of a combination of factors. The interest encoding 206 may represent an interest in a video game franchise, a video game, a animation style, an art style, a difficulty, a genre, single player video games, multi-player video games, game lengths, storylines, mechanics, characters, character classes, progressions systems, replay ability, play choice, first person shooters, strategy video games, co-op video games, achievements, sound, world size, puzzles, exploration, boss fights, player versus player gameplay, collecting, outfits, aesthetics, driving, riding, flying, spell casting, speedrunning, strong female leads, bipoc leads, historical era, narrative heavy, and/or single path narrative, etc. The mentioned list is meant to be explanatory and not limiting. One of ordinary skill in the art with the benefit of the present disclosure would recognize other interests that a video game user may have.

The interest encoding may include an encoding of the game console data 202. For example, the interest encoding 206 may include a vector representation of the game console data 202 in a vector space (e.g., an embedding is a form of an encoding). The interest determination system 204 may generate the vector space using an encoding model that has been trained to encode the game console data 202 into the vector representation. The interest encoding 206 can be used as a vector representation of the user's interests.

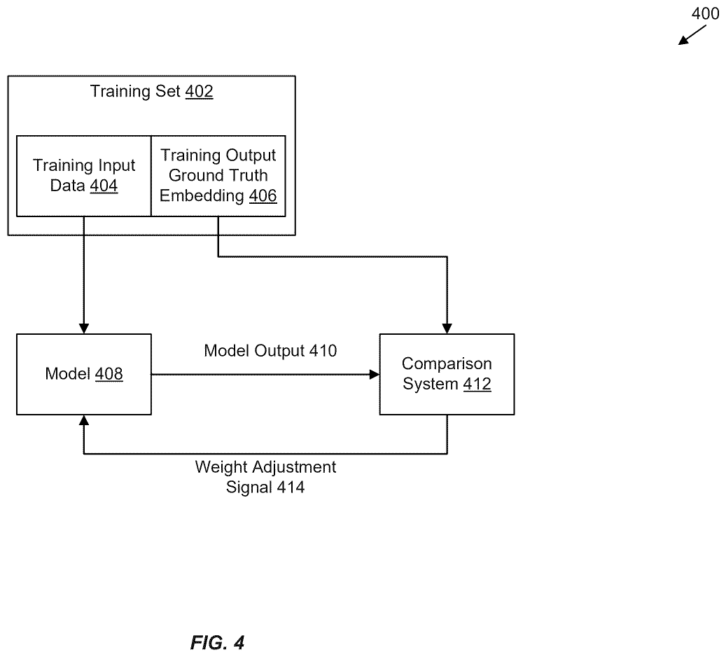

In certain embodiments, the interest determination system 204 includes a machine learning model. The machine learning model (e.g., encoding model, classification model) may include frozen parameter weights. The machine learning model may include a pretrained model. The machine learning model may be trained using game console data 202 and/or interests of other users. Training of the machine learning model is further described below (e.g., with respect to FIG. 4).

In certain embodiments, the interest encoding 206 represents a classification determined using the game console data 202 by a classification machine learning model. The interest encoding may indicate that the game console data 202 represents one or more interests. For example, the classification(s) may indicate that the game console data 202 is representative of a user liking action video games, action-adventure video games, mostly action video games that have some adventure aspects, that action games with a particular animation style are of interest to a user, etc. When more than one interest is represented by the interest encoding 206, a first interest may be associated with a first interest weight and a second interest may be associated with a second interest weight. The interest determination system 204 may transmit the interest encoding 206 to the content section selection system 208.

The content section selection system 208, may receive the interest encoding 206. The content section selection system 208 can use the interest encoding 206 to determine, request, and/or select a set of content sections 214. Content sections may include video, audio, images, text, and/or other modality. The set of content sections 214 can be used to generate the trailer 218.

As mentioned above, the content section selection system 208 can determine the set of content sections using the interest encoding 206. The content section selection system 208 may determine the set of content sections 214 by comparing a vector space representation of the interest encoding 206 in a vector space to a vector space representation of content sections in the vector space (e.g., using a clustering machine learning model). The content section selection system 208 may maintain vector embeddings of content sections so that when an interest encoding 206 is received, the interest encoding 206 can be compared to the vector embeddings of the content sections. The closest vector embedding(s) content section(s) to the interest encoding 206 in the vector space can be determined.

The closest vector embedding of the content section may be the most aligned with the interest(s) represented by the interest encoding 206. The closest vector embedding of the content section may be the vector embedding of the content section that is closest in the vector space to the interest encoding 206 in the vector space. A number of closest content sections may be determined to correspond with the interest encoding 206. The number of closest content sections determined may be predefined (e.g., choosing the five closest content section vector representations), the number of closest content sections within a predefined threshold distance, and/or may be determined based on user input (e.g., the user may be able to configure trailer generation attributes so that generated trailers include a certain amount of content sections). In certain embodiments, once a close vector embedding of a content section is determined the content section selection system 208 may generate a content section using the vector embedding of the content section (e.g., using a decoder machine learning model).

In certain embodiments, once a close vector embedding of a content section is determined the content section selection system 208 may request the vector embedding from the content section repository 212 using a content section request 210. The requested content section may be identified using the vector embedding of the content section and/or an identifier association with the vector embedding of the content section.

The content section request 210 may be generated based on and/or include the interest encoding 206, user input, user account settings, a content section selection configuration, and/or a network connection bandwidth, etc. The content section request 210 may include an interest encoding 206, the vector representation of a content section, the identifier of the content section, a number of content sections being requested, a requested content section length (e.g., measures in frames, measure in seconds), a requested content section set length (e.g., the summed length of content sections included in the set of content sections), a modality (e.g., video, audio, and/or text, etc.) of content section, and/or types of content sections being requested, etc. Types of video content sections may include the trailer, a different trailer, gameplay (e.g., gameplay of a second user), cutscenes (e.g., in-game cutscenes), or authored content sections, etc.

In certain embodiments, the content section request 210 is not sent because a vector representation (e.g., an encoding) of the set of content sections may be decoded into the set of content sections 214 (e.g., from the vector space to a video domain).

The content section request 210 can be sent to the content section repository 212. The content section repository 212 may store content sections and/or sets of content sections. The content section repository 212 may associate (e.g., via a mapping, via a table) attributes with the content sections and/or sets of content sections. For example, the attributes may include a content section type, a modality, a weight, a content section length, an interest encoding, a content section identifier, a content section vector representation, and/or a set length, etc.

The content section repository 212 may receive the content section request 210 and determine a set of one or more content sections 214 are responsive to the request. One or more content sections may be responsive to the request if the information included in the content section request 210 matches up with or is similar to one or more attributes associated with the content sections stored by the content section repository 212.

In certain embodiments, the content section repository 212 maintains a mapping of content vector representation and corresponding content sections. In certain embodiments, the content section repository 212 maintains a mapping of content section identifiers and corresponding content sections. In certain embodiments, the content section repository 212 determines one or more content sections that match information included in the content section request 210, generates the set of content sections 214 that includes the one or more content sections, and transmits the set of content sections 214 to the content sections selection system 208. In certain embodiments, the content section repository 212 maintains predetermined sets of content sections, determines a set that satisfies the information included in the content section request 210, and transmits the set of content sections 214 that satisfies the content section request 210 to the content sections selection system 208.

In certain embodiments, the set of content sections 214 includes a trailer that is authored and selected from a set of authored trailed for a specific video game. The trailer may be selected to be associated with a user account based the interest encoding 206. The trailer may not need to be transmitted to the trailer generation system 216 before being associated with the user account.

One or more attributes associated with respective content sections may be transmitted to the content section selection system 208 with the respective content sections. For example, a type of a content section and/or a weight associated with the content section may be transmitted with the content section to then be used by the trailer generation system 216 to generate the trailer 218 (e.g., to determine an order of content sections to include in the trailer 218, to determine how much of a content section to include in the trailer 218, etc.).

The content section selection system 208 may receive the set of content sections 214 from the content section repository 212. In certain embodiments, the content section selection system 208 may assign weight to a content section included in the set of content sections 214 based on the interest encoding 206 and/or based on the type of the content section. For example, the set of content sections 214 may include a first content section that is of a first type (e.g., gameplay) and a second content section that is of a second type (e.g., cutscene). The content section selection system 208 may associate a first weight with the first content section based on the first type, the interest encoding 206, and/or a predetermined content section selection system configuration (e.g., configured by an administrator, configured by a user of a game console, etc.). The content section selection system 208 may associate a second weight with the second content section based on the second type, the interest encoding 206, and/or a predetermined content section selection system configuration.

The content section selection system 208 may transmit the set of content sections 214 to the trailer generation system 216. The content section selection system 208 may transmit one or more attributes associated with the set of content sections 214 to the trailer generation system 216. In certain embodiments, the content sections include in the set of content sections 214 includes audio.

The trailer generation system 216 may receive the set of content sections 214. The trailer generation system 216 may use the set of content sections to generate the trailer 218. The set of content sections 214 may include a single content section, which may be used in whole or in part to generate the trailer 218. The set of content sections 214 may include multiple content sections, that may each be used in whole or in part to generate the trailer 218. The trailer 218 may be generated based on the content sections, the attributes of the content sections (e.g., weights, content section types, content section lengths), the interest encoding, trailer generation system settings, and/or user configures settings, etc.

The trailer generation system 216 may determine an order to include content sections in the trailer 218 based on the interest encoding 206. For example, if a user likes puzzle video games, the trailer 218 for a video game may include puzzle related gameplay closer toward the beginning of the trailer 218 so it is more likely to be viewed before the trailer 218 is no longer being watched.

The trailer generation system 216 may determine an order to include content sections in the trailer 218 based on a predetermined configuration of the trailer generation system 216. For example, the trailer generation system 216 may be preconfigured to put content sections associated with certain attributes (e.g., a certain content type, a certain content length, a certain corresponding game progress point, etc.) before other content sections. For example, the trailer generation system 216 may be preconfigured to be more likely (e.g., using weights) to put content sections associated with certain attributes (e.g., a certain content type, a certain content length, a certain corresponding game progress point, etc.) before other content sections.

The trailer generation system 216 may determine an order to include content sections in the trailer 218 based on the order the content sections are included in a video game or the order of points within the video game that the content sections are associated with. For example, content sections associated with gameplay at the beginning of a video game may be included near the beginning of the trailer 218 so that the trailer has an order that makes sense given a story included in the video game.

The trailer generation system 216 may be configured to include or not include certain content sections in the trailer 218 based on a rating (e.g., everyone, teen, mature, etc.) associated with the content section. For example, trailers generated for a user account that is associated with a certain user age may include certain content sections that are not included in trailers generated for users of another age.

The trailer generation system 216 may determine transitions to include in the trailer 218 between the content sections based on the set of content sections 214, the interest encoding 206, and/or the predetermined trailer generation system configurations. The trailer generation system 216 may use a machine learning model to generate the trailer 218 and/or the transitions. The machine learning model may be the same or different machine learning model than other machine learning models described herein.

In certain embodiments, the trailer 218 may be transmitted to a scoring system that uses the trailer 218 to generate a quality score. The scoring system may generate the quality score based on the trailer 218. The scoring system may additionally generate the quality score based on the interest encoding 206 and/or the game console data 202. In certain embodiments, if the quality score is below a predetermined threshold, the trailer 218 may not be associated with a user account and may not be presented to the user account. Instead, a second trailer may be generated. The second trailer may be generated based on an updated interest encoding, an updated set of content sections, and/or a different set of content sections. The second trailer may include different transitions than the trailer. The second trailer may include a different order and/or portions of content sections than the trailer 218. In certain embodiments, the quality score is used to further configure (e.g., train) the trailer generation system 216. In certain embodiments, if the quality score is above a predetermined threshold, the trailer 218 is presented (e.g., presented to the user account associated with the game console data 202, presented to one or more other users with user accounts). The trailer 218 may be associated with the user account.

In certain embodiments, the trailer 218 is generated without a user of the game console inputting an indication to the game console that generation of the trailer 218 is desired. The trailer 218 may be associated with the user account of the user of the game console. The trailer 218 may be presented to the user after the trailer 218 is generated and a request is received by the game console to present the trailer 218.

For example, in certain embodiments, a user with a user account may be browsing a video game catalog. The video game catalog may be presenting a list of recommended games. Before the user selects any of the recommended games to view more information about the selected recommended game, the game console may transmit game console data 202 to the trailer generation system 108 so that a trailer for each recommended game can be generated based on the interests of the user. In such embodiments, the trailer 218 may be generated and ready for display by the time the user selects any of the recommended games to view more information about the selected game. The trailers generated for the recommended games based on the game console data 202 (e.g., the user's interests) may be associated with the account of the user. The game console may then lookup the trailer associated with the selected game and the user account to cause the trailer 218 to be displayed to the user of the user account.

In certain embodiments, the trailer 218 may be presented on one or more other devices associated with the user account. (e.g., a mobile phone, a tablet, a computer, a television, another game console, etc.).

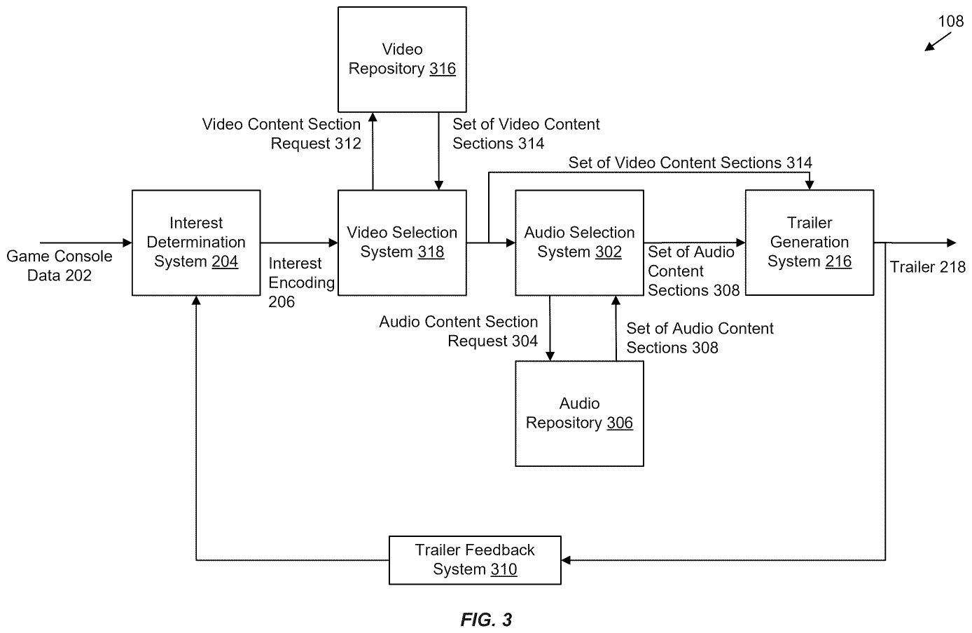

FIG. 3 illustrates an example of a trailer generation system 108 (e.g., trailer generation system 108 described above), according to certain embodiments of the present disclosure. Trailer generation system 108 can include an interest determination system 204 (e.g., interest determination system 204, described above), a video selection system 318 which may be included in the content section selection system 208 described above, a video repository 316 which may be included in the content section repository 212 described above, an audio selection system 302 which may be included in the content sections selection system 208 described above, an audio repository 306 which may be included in the content section repository 212 described above, a trailer generation system 216 (e.g., trailer generation system 216, described above), and a trailer feedback system 310.

The interest determination system 204 may perform operations similar to those describe herein with respect to at least FIG. 2. The video selection system 318 may perform processing like that described with respect to content section selection system 208 described above, but may do so for video modality content. The audio selection system 302 may perform processing like that described with respect to content section selection system 208 described above, but may do so for audio modality content. The video repository 316 may perform processing like that described with respect to content section repository 212 described above, but may do so for video modality content. The audio repository 306 may perform processing like that described with respect to content section repository 212 described above, but may do so for audio modality content. FIG. 3 shows the video repository 316 being separate from the audio repository 306 for the sake of illustration. The repositories may be maintained by one or more systems, and do not need to be separate from one another. Although it has already been described above that content may include one or more modalities (e.g., video, image, audio, text, etc.), FIG. 3 illustrates that the trailer generation system 108 may include one or more modalities of content repositories and/or selection systems. FIG. 3 also illustrates a trailer feedback system 310.

The audio selection system 302 may be local or remote from the audio repository 306. The audio selection system 302 may receive the set of video content sections 314 from the video selection system 318. The audio selection system 302 may determine a set of audio content sections 308 based on the set of video content sections 314. For example, audio that relates to frames included in the set of video content sections 314 may be determined.

The audio selection system 302 may determine a set of audio content sections 308 based on the interest encoding 206. For example, the interest encoding 206 may indicate that a user who uses a user account has an interest in one or more types of audio (e.g., music, vocals, instrumentals, certain instruments, certain tempos, in-game audio, sound effects, etc.).

The audio selection system 302 may determine audio using a machine learning model, such as a classification machine learning model that predicts what music, type of music, etc. corresponds with the set of video content sections 314, game console data 202, and/or the interest encoding 206 that may be input to the machine learning model. The prediction may be generated using a classification machine learning model or a clustering machine learning model.

The audio selection system 302 may generate an audio content section request 304 based on the prediction. The prediction may be represented by a vector. The vector may be decoded to obtain the set of audio content sections 308. The prediction, or a portion of the prediction, may be included in an audio content section request 304. The audio content section request 304 can be sent to the audio repository 306 so the audio repository 306 can perform a lookup using the audio content section request 304.

The audio content section request 304 may include a number of audio clips being requested, a length of an audio clip being requested, a total length of the number of audio clips being requested, a style of audio clip being requested, the set of video content sections 314, the interest encoding 206, and/or the game console data 202, etc.

The audio repository 306 may receive the audio content section request 304 and perform the lookup using the audio content section request 304. The audio repository 306 may maintain a mapping (e.g., represented by a hash graph, a table, etc.) between information that can be included in an audio content section request 304 and audio (e.g., sets of audio). For example, the mapping may indicate that if an audio content section request 304 including a first content section is received, then a first audio clip is returned to the audio selection system 302 included in the set of audio content sections 308. As an example, the mapping may indicate that if the audio content section request 304 includes a second content section is received, then a second audio clip is returned to the audio selection system 302 included in the set of audio content sections 308. The set of audio content sections 308 may include one or more distinct audio clips.

In certain embodiments, the interest determination system 204 generates a first interest used by the video selection system 318 and a second interest that is different from the first interest that is used by the audio selection system 302.

In certain embodiments, the audio selection system 302 is configured to generate the set of audio content sections 308. The audio selection system 302 may generate the set of audio content sections 308 using a machine learning model (e.g., a generative machine learning model such as a diffusion-based machine learning model). The machine learning model may use the set of video content sections 314, or a portion of the set, to condition the machine learning model when generating the set of audio content sections 308.

The audio selection system 302 may transmit the set of audio content sections 308 to the trailer generation system 216. The trailer generation system 216 may receive the set of audio content sections 308 from the audio selection system 302 and/or the set of video content sections 314 from the video selection system 318.

The trailer generation system 216 may determine which audio clips to combine with the video content sections to generate the trailer 218. The determination may be based on the order of the video content sections included in the set of video content sections 314, the order of audio clips included in the set of audio content sections 308, how many video content sections are included in the set of video content sections 314, the types of content video sections and/or other attributes associated with the video sections), attributes associated with the audio clips/sections, when transitions occur between video content sections, how fast transitions occur between video content sections, a video game associated with the video or audio content sections, and/or the user account the trailer is being generated for (e.g., the user account may be associated with an age or range of ages), etc.

In certain embodiments, the trailer generation system 216 may determine and/or generate text content to include in the trailer 218. The text content may be overlaid on the video content sections. The text content may be correspond to specific audio clips and/or video content sections. The text content may be determined based on the video game the trailer 218 is being generated for. The text content may be based on the game console data 202 and/or the interest encoding 206. For example, the text content may help highlight features shown by the trailer 218 that align with interests of a user associated with a user account. The text content may be determined using a text repository in a similar manner like the set of video content sections 314 and/or the set of audio content sections 308 are determined. The text content may be generated by a machine learning model. The machine learning model may be a generative machine learning model (e.g., a large language model).

In certain embodiments, after the trailer 218 is generated, the trailer 218 is transmitted to the trailer feedback system 310. The trailer feedback system 310 may additionally or alternatively receive other input such as user feedback. The user feedback may include how long the trailer 218 was presented, how many times the trailer 218 was presented, how many times the trailer 218 was shared, how many likes the trailer 218 is associated with, a time between the trailer 218 being presented and the video game being played, or how long the video game was played for, a user account the feedback is associated with. The trailer feedback system 310 may use the input to determine how to adjust one or more models included in the trailer generation system 108. For example, the trailer feedback system 310 may determine that the interest determination system 204 needs to be tuned (e.g., different parameters used, different weights used for certain parameters, different logic used, etc.) to cause how the interest encoding is subsequently generated to be changed. Similarly, the trailer feedback system 310 may tune other machine learning models, such as a clustering model, a generative model, a content selection system (e.g., content selection system 208, video selection system 318, audio selection system 302, a text selection system) to change how content is selected, the trailer generation system 216 to change how the trailer 218 is generated, etc.

FIG. 4 illustrates an example of a system 400 for training a machine learning model, according to certain embodiments of the present disclosure. The system 400 may include a training set 402. The training set 402 may include training input data 404. The training set 402 may include a training output ground truth embedding 406. System 400 may include a model 408. The model 408 may include a game data encoding model (e.g., used to generate interest encoding 206), an interest classification model (e.g., used to generate interest encoding 206), an interest clustering model (e.g., used to determine content sections based on interest encodings), an interest decoding model (e.g., used to determine an interest classification based on an interest vector), a content generation model (e.g., a generative model used by a content section selection system 208 to generate content sections), an audio generation model (e.g., a generative model used by the audio selection system 302 to generate audio clips), a text generation model (e.g., a generative model used by the trailer generation system to generate text), trailer generation model (e.g., a model used by the trailer generation system 216 to generate transitions, trailers using content sections, etc.), and/or a trailer scoring model (e.g., used by the trailer generation system 216) to generate a score for a trailer, etc. System 400 may include a comparison system 412.

The model 408 may be trained using the comparison system 412. Comparison system 412 may compare model output 410 (e.g., an interest encoding, a classification, a content selection, an audio selection, a trailer quality score) generated by the model 408 to a training output ground truth embedding 406 (e.g., a ground truth interest encoding, a ground truth classification, a ground truth content selection, a ground truth audio selection, a ground truth trailer quality score). Training output ground truth embedding 406 may be associated with the training input data 404 used by the model 408 to generate the model output 410. Based on the comparison of the training output ground truth embedding 406 and the model output 410, the comparison system 412 may generate a weight adjustment signal 414. The weight adjustment signal 414 may be transmitted to the model 408 to cause adjustment of weights for the model 408. Through iterations, the adjustments can train the model 408 to generate a more accurate embedded model output (e.g., a ground truth interest encoding, a ground truth classification, a ground truth content selection, a ground truth audio selection, a ground truth trailer quality score).

The training set 402 may be used for training the model 408. The training set 402 may include the training input data 404. In certain embodiments, the training input data 404 is encoded training input data. The encoded training input data may have been generated by inputting training input data 404 into an encoder (e.g., an interest encoder, a content section encoder, an audio clip encoder, a trailer encoder). By using encoded training input data (e.g., an encoded interest, an encoded content section, an encoded audio clip, an encoded trailer) rather than converting the training data during training time, the network, processing, and energy resources of the training system 400 can be reduced compared to a system that encodes data at training time. The training set 402 may be stored in a database of training datasets. The training input data 404 may be transmitted to the model 408.

The comparison system 412 may compare the model output 410 with the training output ground truth embedding 406 to determine how similar the training output ground truth embedding 406 is to the model output 410. Based on the comparison, the weight adjustment signal 414 may be transmitted to the model 408 to cause weights of the model 408 to be adjusted. In certain embodiments, the comparison system 412 may compare the model output 410 with the training output ground truth embedding 406 using a loss function such as a mean squared error (MSE).

In certain embodiments, the model 408 is trained to generate an interest encoding based on game console data. In certain embodiments, the interest encoding is included in the model output 410 and represents an interest classification. The training output ground truth embedding 406 may represent a ground truth classification of the training input data. In certain embodiments, the model output 410 may represent an embedding of an interest in a vector space and the training output ground truth embedding 406 may represent a ground truth interest in the vector space. Based on the comparison between the model output 410 and the training output ground truth embedding 406, the model 408 may be adjusted. The trained model 408 may be included in the interest determination system 204, described above.

In certain embodiments, the model 408 is trained to generate an encoding of a content section based on a content section (e.g., an image, a video, and/or other modality). The content section may be included in the training input data 404. In certain embodiments, the encoding of the content section is included in the model output 410 and represents an encoding of the content. The training output ground truth embedding 406 may represent a ground truth encoding of the of the content section. Based on the comparison between the model output 410 and the training output ground truth embedding 406, the model 408 may be adjusted. The trained model 408 may be included in the content section selection system 208, described above.

In certain embodiments, the model 408 is trained to select one or more content sections or one or more audio clips (e.g., using a vector space clustering algorithm). The model 408 may receive training input data 404 that includes a content section request (e.g., content section request 210 described above). The model 408 may receive training input data 404 that includes an audio request (e.g., audio content section request 304 described above). The model may determine a number of content sections and/or audio clips that satisfy the content section request before including the content sections in model output 410. The number of content sections and/or audio clips may be determined based on a field in the content section and/or request, a predetermined configuration, and/or a number of content sections and/or audio clips within a threshold tolerance for the content section request. The training output ground truth embedding 406 may represent a set of content sections and/or audio clips that correspond with the training input data 404. Based on the comparison between the model output 410 and the training output ground truth embedding 406, the model 408 may be adjusted. The trained model 408 may be included in the content section selection system 208 and/or the audio selection system 302, described above.

In certain embodiments, the model 408 is trained to generate an quality score of a trailer. A higher quality score may correspond to a trailer that more accurately appeals and/or reflects the interests of a user account the trailer was generated for. A higher quality score may be generated based on a number of likes, shares, interactions, plays, clicks, etc. associated with the trailer. A higher quality score may be generated based on a number purchases after the trailer was presented, playtime of a video game after the trailer for the video game was presented, etc. The trailer may be included in the training input data 404. In certain embodiments, a quality score encoding for the trailer is included in the model output 410 and represents a quality score for the trailer. The training output ground truth embedding 406 may represent a ground truth quality score for the trailer. Based on the comparison between the model output 410 and the training output ground truth embedding 406, the model 408 may be adjusted. The trained model 408 may be included in the trailer feedback system 310 and/or trailer generation system 216, described above.

One having ordinary skill in the art with the benefit of the present disclosures would recognize how other models described herein could be trained to perform the describes processing. The techniques for training models described herein are not meant to be limiting, but as example implementations.

The processing depicted in process 500, and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in process 500, other FIGS., and described herein are intended to be illustrative and non-limiting. Although process 500, and other FIGS, depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in process 500, and other FIGS, may include a greater number or a lesser number of steps than those depicted in the respective FIGS.

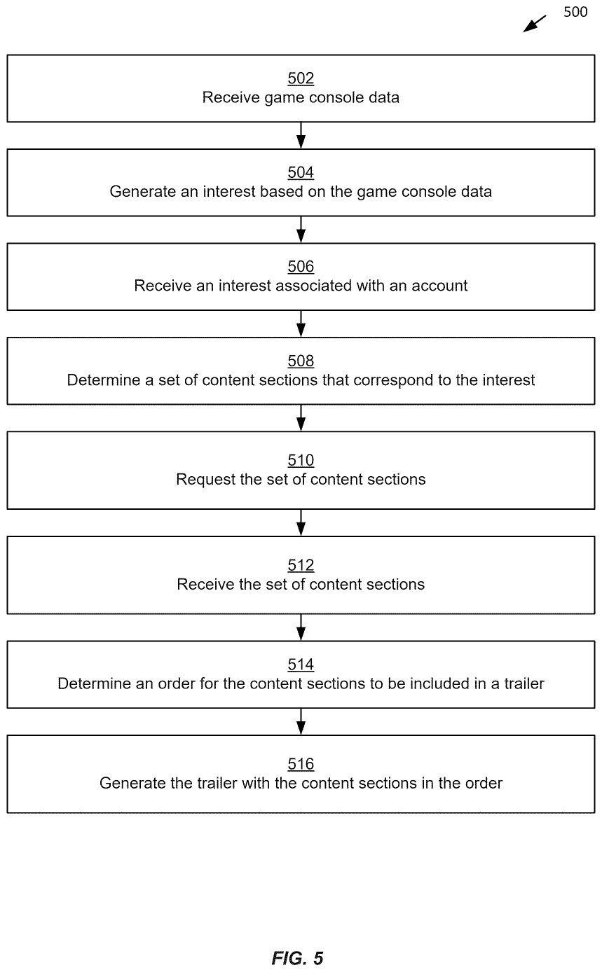

FIG. 5 illustrates an example of a process 500 for using a trailer generation system (e.g., trailer generation system 108 described above), according to certain embodiments of the present disclosure. The process may be performed to generate a trailer (e.g., trailer 218) based on interests of a user (e.g., user 122). The interests of the user may be determined using game data. The trailer may be generated for a specific video game or series of video games.

At 502, game console data may be received (e.g., by interest determination system 204). The game console data may be received over time and/or from one or more game consols. The game console data may include different types of data (e.g., game application data, music application data, etc.), as described above. The game console data may include explicit and/or implicit representations of interests corresponding to a user account associated with the game console data.

At 504, the game console data can be used to generate an interest encoding. The interest encoding may include a vector space representation of the game console data (e.g., generated by a machine learning model). The interest encoding may be generated using an interest determination system (e.g., interest determination system 204). The interest encoding may represent one or more interests determined from the game console data.

The interests may be determined based on when game console data was received (e.g., more recent game console data may be more indicate/more heavily weighted than game console data from longer ago, such as a year ago), where the game console data was received from (e.g., game console data from a portable touch screen game console may represent interests in different types of games compared to game console data received from a non-portable game console that uses a controller).

At 506, the interest encoding can be received (e.g., by content section selection system 208, described above). The interest encoding may have been received from the system that performs the processing described with respect to step 504, described above.

At 508, the interest encoding may be used to determine a set of one or more content sections that correspond to the interest. The set of content sections has been described above in further detail (e.g., with respect to FIG. 2). In certain embodiments, the set of content sections can be determined by determining which vector representation of content sections are closest in a vector space to interest encodings. A number closest content sections vectors (e.g., within a threshold vector distance, a predefined number of closest) may represent content sections. The content sections represented by the content section vectors may be requested (e.g., from content section repository 212, described above).

In certain embodiments, the interest encoding can be used to generate a content section request that includes criteria for a set of content sections (e.g., like a search request with one or more search terms/conditions for a content section repository to use for searching for matching content sections). The content section request may include the interest encoding, a set of interest, interest weightings, a content section length, a content section length limit, content types, a video game identifier, etc.

At 510, the content section request may be transmitted to a system that stores content sections (e.g., content section repository 212, described above). The content section repository may receive the content section request and determine a set of content sections based on the request. For example, the content section repository may determine a number of content sections that cumulatively are 60 seconds in length, that correspond to the interest encoding, and that correspond to the video game. The content section repository may transmit the set of content sections to the content section selection system.

At 512, the set of content sections may be received (e.g., by the content section, described above and/or by the trailer generation system 216, described above). The set of content sections may be received responsive to a request for content sections. The set of content sections may be received with content section attributes that detail content section lengths, corresponding plot points, content section types (e.g., cutscene, gameplay, etc.), weighting, mechanic feature, etc.

At 514, an order of the content sections may be determined (e.g., by the trailer generation system 216). The order may be determined based on the content section attributes. For example, the order may be determined based on which content sections appear in a game first. In an example, the order may be determined based on which content sections most closely align with video game features (e.g., mechanics, playstyle, graphics, animation, etc.) represented by the interest encoding to be of interest to a user of a user account.

At 516, the trailer may be generated. The trailer may be generated by a trailer generation system (e.g., trailer generation system 216). The trailer may be generated to include the content sections. The trailer may be generated based on the order determined at step 514 and/or transitions included between content sections.

In certain embodiments, audio clips can be selected, received, and/or generated based on the interest encoding or an audio interest encoding generated separately from the interest encoding. In certain implementations, audio is included in content sections and is not separate from the content sections. In certain embodiments, the trailer generation system can combine one or more audio clips with a content section when generating the trailer. In certain embodiments, the trailer generation system can combine an audio clip with one or more content sections when generating the trailer.

In certain embodiments, based on user feedback and/or a trailer quality score the trailer may be regenerated and/or components of the trailer generation system may be updated/reconfigured such that subsequently generated trailers are generated according to a different configuration (e.g., machine learning parameters, machine learning parameter weights, etc.).

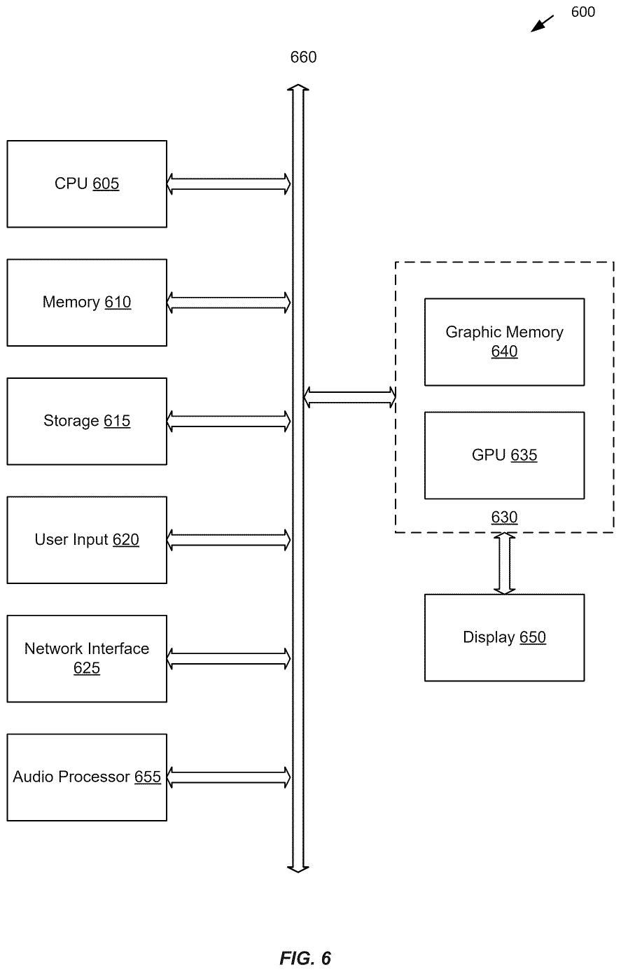

FIG. 6 illustrates an example of a hardware system suitable for implementing a computer system, according to embodiments of the present disclosure. The computer system 600 represents, for example, a video game system, a backend set of servers, or other types of a computer system. The computer system 600 includes a central processing unit (CPU) 605 for running software applications and optionally an operating system. The CPU 605 may be made up of one or more homogeneous or heterogeneous processing cores. Memory 610 stores applications and data for use by the CPU 605. Storage 615 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 620 communicate user inputs from one or more users to the computer system 600, examples of which may include keyboards, mice, thumb sticks, touch pads, touch screens, still or video cameras, and/or microphones. Network interface 625 allows the computer system 600 to communicate with other computer systems via an electronic communications network and may include wired or wireless communication over local area networks and wide area networks such as the Internet. An audio processor 655 is adapted to generate analog or digital audio output from instructions and/or data provided by the CPU 605, memory 610, and/or storage 615. The components of computer system 600, including the CPU 605, memory 610, data storage 615, user input devices 620, network interface 625, and audio processor 655 are connected via one or more data buses 660.

A graphics subsystem 630 is further connected with the data bus 660 and the components of the computer system 600. The graphics subsystem 630 includes a graphics processing unit (GPU) 635 and graphics memory 640. The graphics memory 640 includes a display memory (e.g., a frame buffer) used for storing pixel data for each pixel of an output image. The graphics memory 640 can be integrated in the same device as the GPU 635, connected as a separate device with the GPU 635, and/or implemented within the memory 610. Pixel data can be provided to the graphics memory 640 directly from the CPU 605. Alternatively, the CPU 605 provides the GPU 635 with data and/or instructions defining the desired output images, from which the GPU 635 generates the pixel data of one or more output images. The data and/or instructions defining the desired output images can be stored in the memory 610 and/or graphics memory 640. In an embodiment, the GPU 635 includes 3D rendering capabilities for generating pixel data for output images from instructions and data defining the geometry, lighting, shading, texturing, motion, and/or camera parameters for a scene. The GPU 635 can further include one or more programmable execution units capable of executing shader programs.

The graphics subsystem 630 periodically outputs pixel data for an image from the graphics memory 640 to be displayed on the display device 650. The display device 650 can be any device capable of displaying visual information in response to a signal from the computer system 600, including CRT, LCD, plasma, and OLED displays. The computer system 600 can provide the display device 650 with an analog or digital signal.

In accordance with various embodiments, the CPU 605 is one or more general-purpose microprocessors having one or more processing cores. Further embodiments can be implemented using one or more CPUs 605 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method including
determining an interest of a user based at least in part on game console data associated with an account of the user;
determining, based at least in part on the interest of the user, a set of content sections from video content of a video game;
generating a trailer for the video game based at least in part on the set of content sections; and
causing a presentation of the trailer on a user device associated with the account.

2. The method of claim 1, wherein determining the interest comprises:
generating, based at least in part on different game console data associated with a different account, a vector representation of the game console data in a vector space.

3. The method of claim 2, wherein the set of content sections is determined by at least matching the interest with a content section based at least in part on the vector representation.

4. The method of claim 1, wherein the set of content sections includes at least one of cutscenes, gameplay of a second user, or authored content sections.

5. The method of claim 1, wherein generating the trailer comprises:
determining content based at least in part on the video game, wherein the content includes at least one of audio or text; and
including the content in the trailer.

6. The method of claim 5, wherein the audio is determined by selecting, based at least in part on the account of the user or the interest of the user, audio from a set of audio associated with the video game.

7. The method of claim 6, wherein the text is determined by generating the text using a generative machine learning model based at least in part on the video game, the account of the user, or the interest of the user.

8. A system comprising:
one or more storage media storing instructions; and
one or more processors configured to execute the instructions causing the system to perform operations comprising:
determining an interest of a user based at least in part on game console data associated with an account of the user;
determining, based at least in part on the interest of the user, a set of content sections from video content of a video game;
generating a trailer for the video game based at least in part on the set of content sections; and
causing a presentation of the trailer on a user device associated with the account.

9. The system of claim 8, wherein generating the trailer comprises:
determining, using a first machine learning model, an order of content sections included in the set of content section for inclusion in the trailer; and
generating the trailer to include the content sections in the order.

10. The system of claim 9, wherein the order is based at least in part on an order of events in the video game.

11. The system of claim 9, wherein the order is based at least in part on the interest of the user.

12. The system of claim 9, wherein executing the instructions further causes the system to perform operations comprising:
generating, using the first machine learning model or a second machine learning model, transitions between the content sections included in the trailer.

13. The system of claim 8, wherein the interest of the user includes a weighted combination of a first interest and a second interest, and wherein the set of content sections are determined based at least in part on the weighted combination.

14. The system of claim 8, wherein the interest of the user is influenced by the game console data received more recently than the game console data received before the game console data received more recently.

15. The system of claim 8, wherein the interest of the user represents multiple video game feature interests.

16. One or more non-transitory computer-readable storage media storing instructions that, upon execution by one or more processors of a system, cause the system to perform operations comprising:
determining an interest of a user based at least in part on game console data associated with an account of the user;
determining, based at least in part on the interest of the user, a set of content sections from video content of a video game;
generating a trailer for the video game based at least in part on the set of content sections; and
causing a presentation of the trailer on a user device associated with the account.

17. The non-transitory computer-readable storage media of claim 16, wherein the instructions, upon execution, further cause the system to perform operations further comprising:
receiving feedback for the trailer; and
adjusting at least one a first machine learning model trained to generate the interest of the user or a second machine learning model trained to generate the trailer.

18. The non-transitory computer-readable storage media of claim 17, wherein the feedback includes at least one of how long the trailer was presented, how many times the trailer was presented, how many times the trailer was shared, how many likes the trailer is associated with, a time between the trailer being presented and the video game being played, or how long the video game was played for.

19. The non-transitory computer-readable storage media of claim 16, wherein the set of content sections includes a first content section that is of a first type and that is associated with a first weight and a second content section that is of a second type and that is associated with a second weight, wherein the first weight is based at least in part on the first type; and
wherein generating the trailer is based at least in part on the first weight and the second weight.

20. The non-transitory computer-readable storage media of claim 16, wherein the instructions, upon execution, further cause the system to perform operations further comprising:
generating, using a machine learning model, a quality score for the trailer; and
responsive to the quality score for the trailer being above a predetermined threshold, associating the trailer with the account.
